(19) United States
(12) Patent Application Publication
(10) Pub. No.: US 2019/0248610 A1
(43) Pub. Date: Aug. 15, 2019

(54) SHEET CONVEYING DEVICE AND IMAGE FORMING DEVICE

(71) Applicant: Konica Minolta, Inc., Tokyo (JP)

(72) Inventors: Takayuki YOKOYAMA, Tokyo (JP); Yutaka HOKAZONO, Tokyo (JP)

(21) Appl. No.: 16/268,964

(22) Filed: Feb. 6, 2019

(30) Foreign Application Priority Data
Feb. 9, 2018 (JP) 2018-021586

(51) Int. Cl. B65H 5/02; B65H 11/00; B41J 11/00; B41J 11/02; B41J 2/01

(52) U.S. Cl. CPC B65H 5/021; B65H 11/005; B41J 2/01; B41J 11/02; B41J 11/007

(57) ABSTRACT

A sheet conveying device includes a first conveyer and a second conveyer, each including a upstream-side pulley and a downstream-side pulley with respect to a conveying direction, an endless belt stretched around these pulleys, and a suction mechanism provided on an inner periphery relative to a conveying surface of the endless belt, along the conveying direction, wherein a third conveyer including a upstream-side pulley and a downstream-side pulley relative to the conveying direction and an endless belt stretched around these pulleys is provided between the first conveyer and the second conveyer, and in a state where the third conveyer is viewed from a side of the conveying surface, the upstream-side pulley of the third conveyer is arranged to be overlapped with the downstream-side pulley of the first conveyer, and the downstream-side pulley of the third conveyer is arranged to be overlapped with the upstream-side pulley of the second conveyer.

### CROSS-REFERENCE TO RELATED APPLICATION

The present invention claims priority under 35 U.S.C. § 119 to Japanese Patent Application No. 2018-021586, filed on Feb. 9, 2018, the entire contents of which are incorporated herein by reference.

### BACKGROUND

### Technological Field

The present invention relates to a sheet conveying device and an image forming device including the sheet conveying device.

### Description of the Related Art

An image forming device includes a sheet conveying device for conveying a sheet-like recording medium to each processor. The sheet conveying device has a configuration in which a plurality of conveyers for conveying the sheet by attracting the sheet to a belt is arranged along a conveying direction of the sheet. Each conveyer has a configuration in which an endless belt is wound around a plurality of pulleys and a suction fan is provided on a side of an inner periphery of the endless belt. In the conveyer, the sheet is attracted to the side of the outer periphery of the endless belt by suctioning it, and the attracted sheet is conveyed in a circulating direction of the endless belt which circulates as following drive of the pulleys. Furthermore, the sheet conveying device in which the conveyers are arranged includes a guide for guiding the conveyance of the sheet between the conveyers (refer to JP 2015-47702 A).

The sheet conveying device provided in an image forming device is required to convey various sizes and thicknesses of recording media at an accurate position. However, when the size of the sheet to be conveyed is increased, in the conveyer for attracting the sheet to the endless belt and conveying the sheet, an attracting area between the endless belt and the sheet is increased, and a sliding load between the endless belt and a platen for supporting the endless belt is increased. Accordingly, it is necessary to increase a driving torque and a belt tension to circulate the endless belt, and as a result, the diameter of the pulley is increased. Furthermore, regarding the conveyer, when the thickness or rigidity of the sheet to be conveyed is increased, it is necessary to increase an attraction force of the sheet to the endless belt. Accordingly, it is necessary to increase the driving torque and the belt tension to circulate the belt, and the diameter of the pulley is increased.

In the sheet conveying device in which the conveyers described above are arranged in the conveying direction, the increase in the diameter of the pulley widens an interval between conveying surfaces of the conveyers. Here, the conveying surface is a region where the endless belt is maintained to be flat between the pulleys and a region having contact with the conveyed sheet. Accordingly, there is a disadvantage such that a sheet having a size in the conveying direction smaller than the interval between the conveying surfaces cannot be conveyed.

### SUMMARY

An object of the present invention is to provide a sheet conveying device capable of conveying various sizes and thicknesses of sheets and an image forming device including the sheet conveying device.

To achieve the abovementioned object, according to an aspect of the present invention, a sheet conveying device reflecting one aspect of the present invention comprises a belt-attraction-type first conveyer and a belt-attraction-type second conveyer, each including a upstream-side pulley and a downstream-side pulley with respect to a conveying direction, an endless belt stretched around these pulleys, and a suction mechanism provided on a side of an inner periphery relative to a conveying surface of the endless belt, arranged in this order along the conveying direction, wherein a third conveyer including a upstream-side pulley and a downstream-side pulley relative to the conveying direction and an endless belt stretched around these pulleys is provided between the first conveyer and the second conveyer, and in a state where the third conveyer is viewed from a side of the conveying surface, the upstream-side pulley of the third conveyer is arranged to be overlapped with the downstream-side pulley of the first conveyer, and the downstream-side pulley of the third conveyer is arranged to be overlapped with the upstream-side pulley of the second conveyer.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a configuration diagram of a sheet conveying device according to an embodiment;

FIG. 2 is an enlarged front view of a main part of the sheet conveying device according to the embodiment;

FIG. 3 is an enlarged top view of the main part of the sheet conveying device according to the embodiment;

FIG. 4 is a diagram for explaining conveyance of a sheet having the maximum size by the sheet conveying device according to the embodiment;

FIG. 5 is a diagram for explaining conveyance of a sheet having the minimum size by the sheet conveying device according to the embodiment; and

FIG. 6 is a configuration diagram of an image forming device according to the embodiment.

### DETAILED DESCRIPTION OF EMBODIMENTS

Hereinafter, one or more embodiments of the present invention will be described with reference to the drawings. However, the scope of the invention is not limited to the disclosed embodiments.

Embodiments of a sheet conveying device and an image forming device including the sheet conveying device to which the present invention has been applied will be described below in this order.

<<Sheet Conveying Device>>

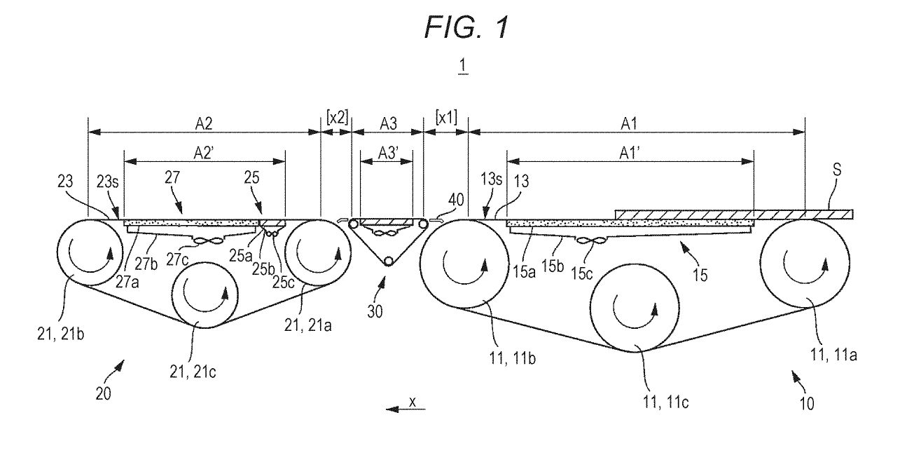

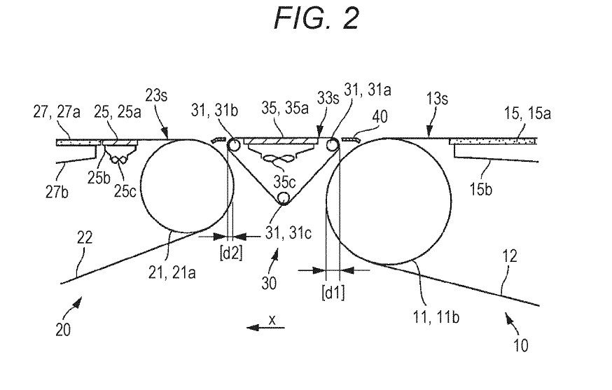

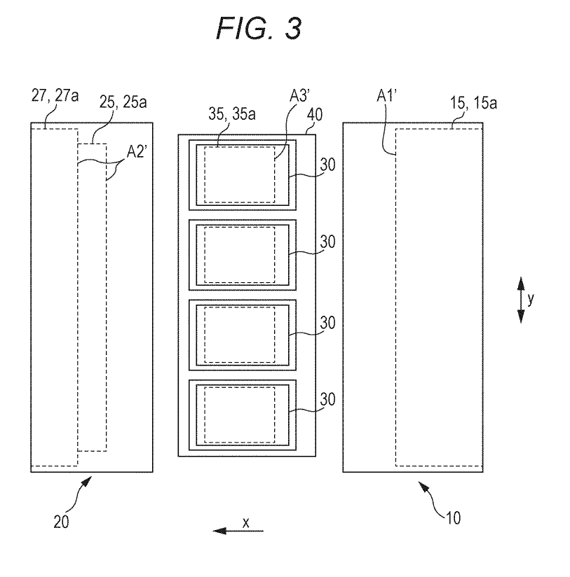

FIG. 1 is a configuration diagram of a sheet conveying device 1 according to an embodiment. FIG. 2 is an enlarged front view of a main part of the sheet conveying device 1 according to the embodiment, and an enlarged view of a center part of FIG. 1. FIG. 3 is an enlarged top view of the main part of the sheet conveying device 1 according to the embodiment, and a view of FIG. 2 as viewed from above. FIG. 3 illustrates a surface having contact with a sheet S in the sheet conveying device 1.

The sheet conveying device 1 illustrated in FIG. 1 to FIG. 3 conveys the sheet S in a predetermined direction. The sheet S is, for example, a recording medium, and is made of ordinary paper materials, thick paper, cardboard paper, resin materials, and cloth materials. The sheet conveying device 1 includes a belt-attraction-type first conveyer 10 provided on the upstream side in a conveying direction x of the sheet S and a belt-attraction-type second conveyer 20 provided on the downstream side in the conveying direction x of the sheet S. In addition, a third conveyer 30 is included between the first conveyer 10 and the second conveyer 20, and this is characteristic arrangement. Hereinafter, configurations of the first conveyer 10, the second conveyer 20, and the third conveyer 30 will be described in this order.

<First Conveyer 10>

The first conveyer 10 is arranged on the upstream side in the conveying direction x of the sheet S with respect to the second conveyer 20 and the third conveyer 30. The first conveyer 10 includes a plurality of pulleys 11, an endless belt 13 stretched around the pulleys 11, and a suction mechanism 15 provided in contact with an inner periphery of the endless belt 13. Hereinafter, configurations of these members included in the first conveyer 10 will be described.

[Pulley 11]

The pulleys 11 include an upstream-side pulley 11a arranged on the upstream side relative to the conveying direction x of the sheet S, a downstream-side pulley 11b arranged on the downstream side, and an intermediate pulley 11c arranged at the middle. One of these pulleys 11 is a driving pulley, and one of these is a driven pulley, and one of these is a tension controlling pulley. Here, as an example, it is assumed that the downstream-side pulley 11b is the driving pulley, the upstream-side pulley 11a is the driven pulley, and the intermediate pulley 11c is the tension controlling pulley. It is assumed that these pulleys 11 have large diameters sufficient for conveyance of the sheet S with any size and any sheet thickness within a range where the conveyance of the sheet S is expected. The diameters of the pulleys 11 may be substantially the same.

—Driving Pulley (Downstream-Side Pulley 11b)—

The driving pulley includes a driving motor which is not shown and freely rotates in a predetermined direction. A rotation speed meter such as a rotary encoder is provided in the driving pulley, and the rotation speed measured by the meter is fed back to the driving motor so as to freely control the rotation speed. Here, since the downstream-side pulley 11b is the driving pulley, a circulation direction of the driving pulley is a direction in which the endless belt 13 rotates around the upstream-side pulley 11a, the downstream-side pulley 11b, and the intermediate pulley 11c in this order.

—Driven Pulley (Upstream-Side Pulley 11a)—

The driven pulley is a pulley arranged in parallel to the driving pulley and freely rotates as following the circulation motion of the endless belt 13 by the rotation of the driving pulley.

—Tension Controlling Pulley (Intermediate Pulley 11c)—

The tension controlling pulley is arranged substantially parallel to the driving pulley and the driven pulley between the driving pulley and the driven pulley and applies pressure from an inner peripheral side toward an outer peripheral side with respect to the endless belt 13. The tension controlling pulley is a driven pulley and has a function as a steering pulley for controlling meandering of the endless belt 13. Such a tension controlling pulley includes a driving mechanism which is not shown and controls pressure to be applied to the endless belt 13 by the driving mechanism.

[Endless Belt 13]

The endless belt 13 is stretched around the plurality of pulleys 11. An outer peripheral surface of the endless belt 13 is a conveying surface 13s of the sheet S. The conveying surface 13s is a surface in the outer peripheral surface of the endless belt 13 having contact with the sheet S, and a region A1 where the endless belt 13 is maintained to be flat between the upstream-side pulley 11a and the downstream-side pulley 11b is the conveying surface 13s.

Furthermore, it is assumed that a width of the endless belt 13 exceed the maximum width of a sheet to be conveyed. Furthermore, the endless belt 13 has a plurality through-holes (not shown) through which air can pass between the outer peripheral surface and the inner peripheral surface. These through-holes are provided on a surface of the region corresponding to the part where the sheet S is placed in a width direction of the endless belt 13, that is, a conveying width direction y perpendicular to the conveying direction x.

Furthermore, such an endless belt 13 is formed of a metal material so as to withstand belt tension and is made of steel as an example. However, the material of the endless belt 13 is not limited to this.

[Suction Mechanism 15]

The suction mechanism 15 is provided in contact with the inner periphery of the endless belt 13 between the upstream-side pulley 11a and the downstream-side pulley 11b. The suction mechanism 15 includes a platen 15a supporting the endless belt 13 from the side of the inner periphery, a suction duct 15b of which one opening is closed by the platen 15a, and a suction fan 15c provided on the other opening of the suction duct 15b.

The platen 15a is a permeable plate member and supports the endless belt 13 from the side of the inner periphery in a wide range between the upstream-side pulley 11a and the downstream-side pulley 11b. In the first conveyer 10, a range where the endless belt 13 is supported by the platen 15a and suctioned by the suction fan 15c coincides a first suction region A1′ which is a suction area of the first conveyer 10.

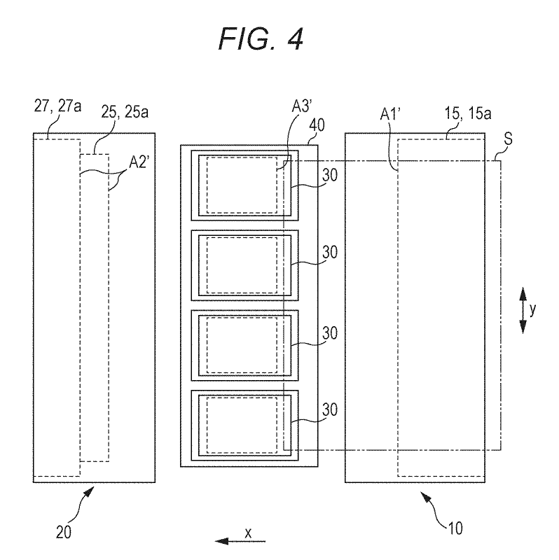

FIG. 4 is a diagram for explaining conveyance of the sheet S having the maximum size by the sheet conveying device 1 according to the embodiment. As illustrated in FIG. 4, it is assumed that a size of the first suction region A1′ in the conveying width direction y exceed the maximum width of the sheet S to be conveyed.

In particular, the platen 15a of the suction mechanism 15 having excellent adhesion to the sheet S by suction via the endless belt 13 is preferably used. As such a platen 15a, for example, a platen 15a formed of a porous material is used, and as a specific example, the platen 15a is formed of a porous polyethylene formed by sintering. The platen 15a formed of a porous material has small suction leakage from holes which are not closed by the sheet S and attracts all sizes of sheets S with excellent adhesion.

The suction duct 15b includes a large-diameter opening closed by the platen 15a and another opening for exhaust. The suction fan 15c is provided in the opening for exhaust of the suction duct 15b and suctions an outer periphery of the conveying surface 13s of the endless belt 13 via the suction duct 15b, the porous platen 15a, and the through-holes of the endless belt 13.

<Second Conveyer 20>

The second conveyer 20 is arranged on the downstream side in the conveying direction x of the sheet S with respect to the first conveyer 10 and the third conveyer 30. The second conveyer 20 includes a plurality of pulleys 21, an endless belt 23 stretched around the pulleys 21, and a upstream-side suction mechanism 25 and a downstream-side suction mechanism 27 provided in contact with the inner periphery of the endless belt 23. Hereinafter, configurations of these members included in the second conveyer 20 will be described.

[Pulley 21]

The pulleys 21 include a upstream-side pulley 21a arranged on the upstream side relative to the conveying direction x of the sheet S, a downstream-side pulley 21b arranged on the downstream side, and an intermediate pulley 21c arranged at the middle. The configuration of each pulley 21 is similar to the configuration of each pulley 11 of the first conveyer 10, and the pulley 21 has a large diameter sufficient for conveyance of the sheet S with any size and any sheet thickness within a range where the conveyance of the sheet S is expected. The diameters of the pulleys 21 may be substantially the same.

[Endless Belt 23]

The configuration of the endless belt 23 is similar to the configuration of the endless belt 13 of the first conveyer 10, and a region A2 where the endless belt 23 is maintained to be flat between the upstream-side pulley 21a and the downstream-side pulley 21b is a conveying surface 23s.

[Upstream-Side Suction Mechanism 25]

The upstream-side suction mechanism 25 is provided in contact with the inner periphery of the endless belt 23 on the upstream side in the conveying direction x of the sheet S between the upstream-side pulley 21a and the downstream-side pulley 21b. The upstream-side suction mechanism 25 includes a platen 25a supporting the endless belt 23 from the side of the inner periphery, a suction duct 25b of which one opening is closed by the platen 25a, and a suction fan 25c provided on the other opening of the suction duct 25b.

The platen 25a is a permeable plate member and supports the endless belt 23 from the side of the inner periphery in a wide range on the side of the upstream-side pulley 21a, particularly, a wide range in the conveying width direction y of the endless belt 23. In the second conveyer 20, a range where the endless belt 23 is supported by the platen 25a and suctioned by the suction fan 25c coincides a upstream side part of a second suction region A2′ which is a suction area of the second conveyer 20. It is preferable that a size of the upstream side part of the second suction region A2′ in the conveying width direction y be substantially the same as the maximum width of the sheet S to be conveyed, and the size may be smaller than the maximum width of the sheet.

In particular, the platen 25a of the upstream-side suction mechanism 25 having a strong suction force relative to the sheet S via the endless belt 23 is preferably used. As such a platen 25a, the platen 25a in which a plurality through-holes is provided in a material having abrasion resistance is preferably used. As an example, it is assumed that the platen 25a having a configuration in which the through-hole is provided in polyacetal by cutting processing is preferably used. The platen 25a in which the plurality through-holes is provided has a strong suction force to attract the sheet S via the through-holes and surely suctions the sheet S conveyed from the side of the first conveyer 10 to be attracted to the endless belt 23.

Furthermore, the suction duct 25b has a configuration in which a large opening is closed by the platen 25a, and strongly suctions the sheet S on the conveying surface 23s of the endless belt 13 via the platen 25a and the through-holes of the endless belt 23 by exhaust air from the suction fan 25c provided in another opening for exhaust.

[Downstream-Side Suction Mechanism 27]

The downstream-side suction mechanism 27 is provided in contact with the inner periphery of the endless belt 23 on the downstream side in the conveying direction x of the sheet S between the upstream-side pulley 21a and the downstream-side pulley 21b. The downstream-side suction mechanism 27 includes a platen 27a supporting the endless belt 23 from the side of the inner periphery, a suction duct 27b of which one opening is closed by the platen 27a, and a suction fan 25c provided on the other opening of the suction duct 27b.

Such a downstream-side suction mechanism 27 has the configuration similar to the suction mechanism 15 provided in the first conveyer 10 and has the platen 27a having excellent adhesion to the sheet S. In the second conveyer 20, a range where the endless belt 23 is supported by the platen 27a and suctioned by the suction fan 27c coincides a downstream side part of the second suction region A2′ which is a suction area of the second conveyer 20. It is assumed that a size of the downstream side part of the second suction region A2′ in the conveying width direction y exceed the maximum width of the sheet S to be conveyed. Note that, most part of the second suction region A2′ may correspond to the downstream-side suction mechanism 27.

<Third Conveyer 30>

The plurality of third conveyers 30 is provided between the first conveyer 10 and the second conveyer 20. The plurality of third conveyers 30 is aligned in the width direction y perpendicular to the conveying direction x of the sheet S. Furthermore, the third conveyer 30 is arranged in each opening provided in a single guide plate 40. With such a configuration, by providing and arranging the plurality of third conveyers 30 in the width direction y perpendicular to the conveying direction x of the sheet S, the conveyance width of each third conveyer 30 is narrowed to suppress a belt sliding load and suppress a belt tension. As described below, the configuration is made to reduce the diameter of the pulley 31. In the illustrated example, an example in which four third conveyers 30 are provided along the conveying width direction y is illustrated. However, it is preferable that the number of arranged third conveyers 30 be appropriately set according to the diameter of the pulley 31 included in the third conveyer 30.

The plurality of third conveyers 30 has the same configuration, and each of the third conveyers 30 includes a plurality of pulleys 31 and an endless belt 33 stretched around the pulleys 31. In particular, the characteristics of the pulley 31 of the third conveyer 30 is a diameter smaller than those of the first conveyer 10 and the second conveyer 20. Furthermore, each third conveyer 30 may be a belt-attraction-type conveyer similar to the first conveyer 10 and the second conveyer 20. In this case, each third conveyer 30 includes a suction mechanism 35 provided in contact with the inner periphery of the endless belt 33.

It is preferable that each of the third conveyers 30 described above partially overlap with at least one of the first conveyer 10 and the second conveyer 20. Here, the term “overlap” refers to a state where the first conveyer 10, the second conveyer 20, and the third conveyer 30 are overlapped with each other in plan view as viewed from a side of the conveying surfaces 13s, 23s, and 33s of the respective endless belts 13, 23, and 33 and does not include a contact state.

In this case, the conveying surface 33s of the third conveyer 30 forms a continuous surface with respect to the conveying surface 13s of the first conveyer 10 and the conveying surface 23s of the second conveyer 20 without a step, and it is assumed that the conveying surfaces 13s, 23s, and 33s be arranged on the substantially same plane. Here, the substantially same plane indicates a plane required for flat conveyance of the sheet S, and this enables to convey the sheet S with higher rigidity and the sheet S with a larger thickness.

Furthermore, overlapping states of the third conveyers 30 with the first conveyer 10 and the second conveyer 20 may be the same. Hereinafter, configurations of these members included in the third conveyer 30 will be described.

[Pulley 31]

The pulleys 31 include a upstream-side pulley 31a arranged on the upstream side relative to the conveying direction x of the sheet S, a downstream-side pulley 31b arranged on the downstream side, and an intermediate pulley 31c arranged at the middle. A configuration of the pulley 31 may be similar to the configuration of the pulley 11 of the first conveyer 10. However, it is assumed that the intermediate pulley 31c be a tension controlling pulley.

Among these pulleys 31, the diameter of the upstream-side pulley 31a is smaller than the diameter of the downstream-side pulley 11b of the first conveyer 10. Furthermore, the diameter of the downstream-side pulley 31b is smaller than the diameter of the upstream-side pulley 21a of the second conveyer 20. Accordingly, the third conveyer 30 can be arranged to be closer to the first conveyer 10 and the second conveyer 20. The diameters of the pulleys 31 are in a range where the sheet S having the minimum size within a range in which the conveyance is expected can be conveyed, and are set as follows.

In the following description, it is assumed that the diameters of the pulleys 11 of the first conveyer 10 be substantially the same, the diameters of the pulleys 21 of the second conveyer 20 be substantially the same, and the diameters of the pulleys 31 of the third conveyer 30 be substantially the same.

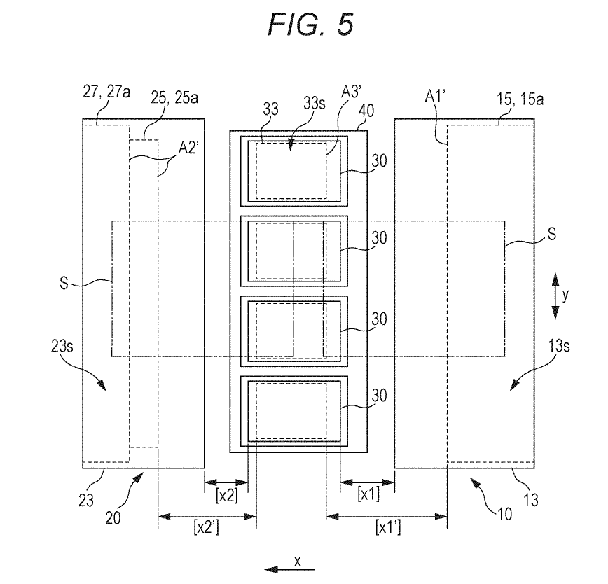

The diameter of the pulley 31 is set based on an interval [x1] between the conveying surface 13s of the first conveyer 10 and the conveying surface 33s of the third conveyer 30 and an interval [x2] between the conveying surface 23s of the second conveyer 20 and the conveying surface 33s of the third conveyer 30. FIG. 5 is a diagram for explaining conveyance of a sheet having the minimum with by the sheet conveying device according to the embodiment. As illustrated in FIG. 5, the diameter of the pulley 31 is set to a size so as to reduce the size of the third conveyer 30 so that the intervals [x1] and [x2] can be sufficiently narrowed than the length of the sheet S to be conveyed having the minimum size in the conveying direction x.

Accordingly, it is possible to take over the conveyance of the sheet S having the minimum size which has been conveyed by the first conveyer 10 from the conveying surface 13s of the first conveyer 10 to the conveying surface 33s of the third conveyer 30. Furthermore, it is possible to take over the conveyance of the sheet S having the minimum size which has been conveyed by the second conveyer 20 from the conveying surface 33s of the third conveyer 30 to the conveying surface 23s of the second conveyer 20.

In addition, in a case where the third conveyer 30 is a belt-attraction-type conveyer as illustrated, it is preferable that the diameter of the pulley 31 be set based on an interval [x1′] between the first suction region A1′ and a third suction region A3′ and an interval [x2′] between the second suction region A2′ and the third suction region A3′. In other words, it is preferable that the diameter of the pulley 31 be set to a size so as to reduce the size of the third conveyer 30 so that the intervals [x1′] and [x2′] can be narrowed than the length of the sheet S to be conveyed having the minimum size in the conveying direction x.

Accordingly, it is possible to take over the conveyance of the sheet S having the minimum size by attracting the sheet S from the first conveyer 10 to the third conveyer 30 at an accurate position, and take over the conveyance of the sheet S by attracting the sheet S to the second conveyer 20.

The diameter of the pulley 31 is a size which enables that the upstream side of the third conveyer 30 is overlapped with the downstream side of the first conveyer 10 and/or the downstream side of the third conveyer 30 is overlapped with the upstream side of the second conveyer 20. In the example illustrated in FIG. 2, the third conveyer 30 is arranged as being overlapped with both of the first conveyer 10 and the second conveyer 20.

Here, a size [d1] of the overlap between the first conveyer 10 and the third conveyer 30 and a size [d2] of the overlap between the second conveyer 20 and the third conveyer 30 are assumed as a size which does not prevent the drive of the tension controlling pulley which is the intermediate pulley 31c. In the example illustrated in FIG. 2, since a state where the third conveyer 30 is arranged to be overlapped with both of the first conveyer 10 and the second conveyer 20 is illustrated, the sizes [d1] and [d2] of the overlaps are positive values. However, in a case where the third conveyer 30 is not overlapped with the other conveyers, the sizes [d1] and [d2] of the overlaps are negative values equal to or less than zero.

However, in a state where the third conveyer 30 is viewed from the side of the conveying surface 33s, it is preferable that at least a part of the upstream-side pulley 31a is arranged to be overlapped with the downstream-side pulley 11b of the first conveyer 10. Accordingly, the interval [x1] between the conveying surface 33s of the third conveyer 30 and the conveying surface 13s of the first conveyer 10 and the interval [x1′] between the third suction region A3′ of the third conveyer 30 and the first suction region A1′ of the first conveyer 10 can be narrowed.

Furthermore, in a state where the third conveyer 30 is viewed from the side of the conveying surface 33s, it is preferable that at least a part of the downstream-side pulley 31b be arranged to be overlapped with the upstream-side pulley 21a of the second conveyer 20. Accordingly, the interval [x2] between the conveying surface 13s of the third conveyer 30 and the conveying surface 23s of the second conveyer 20 and the interval [x2′] between the third suction region A3′ of the third conveyer 30 and the second suction region A2′ of the second conveyer 20 can be narrowed.

Note that, the diameter of the pulley 31 described above depends on the size of the third conveyer 30 in the conveying width direction y, and since a driving torque and a belt tension to circulate the endless belt 33 can be reduced as the size in the conveying width direction y is smaller, the diameter can be set to a small value. Therefore, the number of third conveyers 30 arranged between the first conveyer 10 and the second conveyer 20 depends on the diameters of the pulleys 31.

[Endless Belt 33]

The endless belt 33 is stretched around the plurality of pulleys 31. An outer peripheral surface of the endless belt 33 is the conveying surface 33s of the sheet S. The conveying surface 33s is a surface in the outer peripheral surface of the endless belt 33 having contact with the sheet S, and a region A3 where the endless belt 33 is maintained to be flat between the upstream-side pulley 31a and the downstream-side pulley 31b is the conveying surface 33s.

Note that it is preferable that, regarding the conveying surface 33s of the endless belt 33, a length in the conveying width direction y substantially perpendicular to the conveying direction be shorter than the length in the conveying direction x. Accordingly, it is possible to narrow the conveyance width as possible to suppress a belt sliding load and to suppress the belt tension to reduce an axial load of the pulley, this can also reduce the diameter of the pulley 31. In addition, with this configuration, straightness of the sheet conveyance is enhanced.

Furthermore, the endless belt 33 has a plurality through-holes (not shown) through which air can pass between the outer peripheral surface and the inner peripheral surface. These through-holes are provided at a part corresponding to a place where the sheet S is placed in the width direction y of the endless belt 33. As a material of the endless belt 33, a material having a lower rigidity than the endless belt 13 of the first conveyer 10 and the endless belt 23 of the second conveyer 20 is preferably used. When the endless belt 33 is configured of the material with the lower rigidity, a minimum bending diameter can be reduced, and as a result, the diameter of the pulley 31 can be reduced. Furthermore, slipping between the endless belt 33 and the pulley 31 can be prevented, and a belt tension can be suppressed to be small. Therefore, the endless belt 33 with the lower rigidity can be preferably applied as the endless belt 33 stretched around the pulley 31 having a small diameter. Such an endless belt 33 is formed of rubber, for example.

[Suction Mechanism 35]

The suction mechanism 35 is provided in contact with the inner periphery of the endless belt 33 between the upstream-side pulley 31a and the downstream-side pulley 31b. Such a suction mechanism 35 has a configuration similar to the upstream-side suction mechanism 25 provided in the second conveyer 20, and includes a platen 35a having a strong suction force to the sheet S, that is, the platen 35a in which the plurality of through-holes is provided. Accordingly, the sheet S conveyed from the first conveyer 10 can be attracted to the third suction region A3′ of the third conveyer 30 with a strong suction force.

In the third conveyer 30, a range where the endless belt 33 is supported by the platen 35a and suctioned by a suction fan 35c coincides the third suction region A3′ which is a suction area of the third conveyer 30 described above. It is preferable that the size of the third suction region A3′ in the conveying width direction y be a size determined based on the width of the endless belt 33 and the length of the pulley 31, around which the endless belt 33 is stretched, in the axial direction.

When the third conveyer 30 is a belt-attraction-type conveyer including the suction mechanism 35, the sheet S conveyed from the first conveyer 10 can be taken over to the second conveyer 20 as conveying the sheet S at an accurate position by attracting the sheet S.

<Effect of Sheet Conveying Device>

The configuration of the sheet conveying device 1 described above is a configuration in which the third conveyer 30 of which the diameter of the pulley is small is provided between the belt-suction-type first conveyer 10 and second conveyer 20 of which the diameters of the pulleys 11 and 21 are increased since the conveyance of the sheet S having a large size, a large thickness, or a high rigidity is enabled. Accordingly, between the first conveyer 10 and the second conveyer 20 where an interval between the conveying surface 13s and the conveying surface 23s is widened due to the increase in the diameters of the pulleys 11 and 21, the third conveyer 30 of which the diameters of the pulleys are small conveys the sheet S. In this case, the interval between the sheet conveying surfaces and the interval between the suction regions can be narrower than the configuration in which the first conveyer 10 and the second conveyer 20 having the pulleys 11 and 21 with the increased diameters are directly aligned and arranged. Therefore, even the sheet S which is short in the conveying direction x can be conveyed from the first conveyer 10 to the third conveyer 30, and in addition, conveyed from the third conveyer 30 to the second conveyer 20. Furthermore, by arranging the third conveyer 30 as overlapping a part of the third conveyer 30 with at least one of the first conveyer 10 and the second conveyer 20 between the belt-suction-type first conveyer 10 and second conveyer 20 of which the diameters of the pulleys 11 and 21 are increased, the interval between the sheet conveying surfaces and the interval between the suction regions can be narrowed. As described above, it is possible to convey the sheet S with a large size, a large thickness, or a higher rigidity, and in addition, to convey the sheet S which is shorter in the conveying direction x. As a result, various sizes and thicknesses of the sheets can be reliably conveyed.

<<Image Forming Device>>

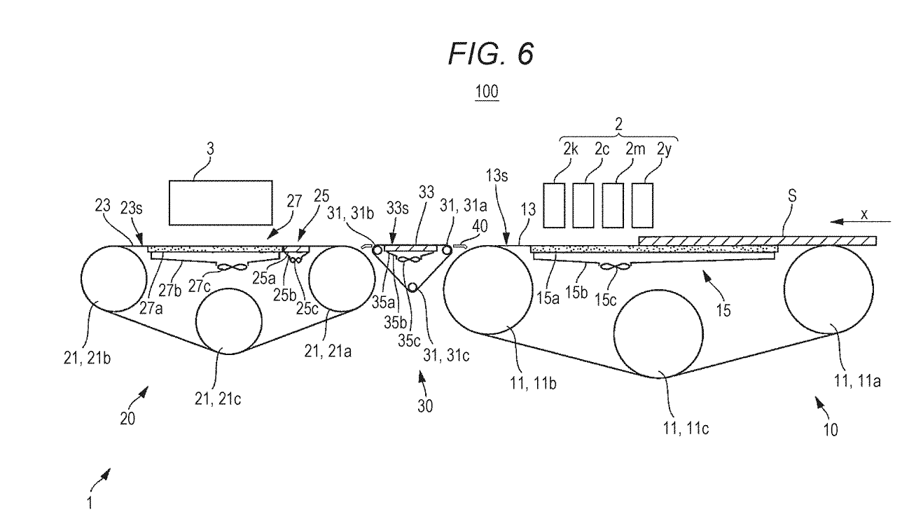

FIG. 6 is a configuration diagram of an image forming device according to the embodiment, and a diagram of an inkjet-type image forming device including the sheet conveying device 1 described above as viewed from the side. As illustrated in FIG. 6, an inkjet-type image forming device 100 includes the sheet conveying device 1, an image former 2, and an image post-processor 3.

The sheet conveying device 1 has the configuration described above with reference to FIG. 1 to FIG. 5.

The image former 2 supplies ink to the sheet S which is a recording medium conveyed by the sheet conveying device 1. The image former 2 is provided as facing the conveying surface 13s of the first conveyer 10 and has a configuration in which ink heads for supplying inks of respective colors are aligned and provided along the conveying direction x of the sheet S. As an example, a configuration in which a yellow ink head 2y, a magenta ink head 2m, a cyan ink head 2c, and a black ink head 2k are arranged along the conveying direction x of the sheet S in order is illustrated. However, the order is not limited to this. It is assumed that the ink heads 2y, 2m, 2c, and 2k be provided across the conveying width direction y of the endless belt 13.

For example, the image post-processor 3 fixes ink on the sheet S by irradiating light, and for example, is an ultraviolet irradiation device. The image post-processor 3 is provided as facing the conveying surface 23s of the second conveyer 20 and provided across the conveying width direction y and along the conveying direction x of the sheet S. Note that the image post-processor 3 is not limited to this and, for example, may be a drying device.

<Effect of Image Forming Device 100>

The image forming device 100 described above includes the sheet conveying device 1 described above. Therefore, various sizes and thicknesses of the sheets can be reliably conveyed from the first conveyer 10 including the image former 2 to the second conveyer 20 including the image post-processor 3.

Although embodiments of the present invention have been described and illustrated in detail, the disclosed embodiments are made for purposes of illustration and example only and not limitation. The scope of the present invention should be interpreted by terms of the appended claims.

What is claimed is:

1. A sheet conveying device comprising a belt-attraction-type first conveyer and a belt-attraction-type second conveyer, each including a upstream-side pulley and a downstream-side pulley with respect to a conveying direction, an endless belt stretched around these pulleys, and a suction mechanism provided on a side of an inner periphery relative to a conveying surface of the endless belt, arranged in this order along the conveying direction, wherein
a third conveyer including a upstream-side pulley and a downstream-side pulley relative to the conveying direction and an endless belt stretched around these pulleys is provided between the first conveyer and the second conveyer, and
in a state where the third conveyer is viewed from a side of the conveying surface, the upstream-side pulley of the third conveyer is arranged to be overlapped with the downstream-side pulley of the first conveyer, and the downstream-side pulley of the third conveyer is arranged to be overlapped with the upstream-side pulley of the second conveyer.

2. A sheet conveying device comprising a belt-attraction-type first conveyer and a belt-attraction-type second conveyer, each including a upstream-side pulley and a downstream-side pulley with respect to a conveying direction, an endless belt stretched around these pulleys, and a suction mechanism provided on a side of an inner periphery relative to a conveying surface of the endless belt, arranged in this order along the conveying direction, wherein
a third conveyer including a upstream-side pulley and a downstream-side pulley relative to the conveying direction and an endless belt stretched around these pulleys is provided between the first conveyer and the second conveyer,
a diameter of the upstream-side pulley of the third conveyer is smaller than a diameter of the downstream-side pulley of the first conveyer, and
a diameter of the downstream-side pulley of the third conveyer is smaller than a diameter of the upstream-side pulley of the second conveyer.

3. The sheet conveying device according to claim 2, wherein
in a state where the third conveyer is viewed from the side of the conveying surface, the upstream-side pulley of the third conveyer is arranged to be overlapped with the downstream-side pulley of the first conveyer.

4. The sheet conveying device according to claim 2, wherein
in a state where the third conveyer is viewed from the side of the conveying surface, the downstream-side pulley of the third conveyer is arranged to be overlapped with the upstream-side pulley of the second conveyer.

5. The sheet conveying device according to claim 1, wherein
the plurality of third conveyers is arranged between the first conveyer and the second conveyer and aligned along a conveying width direction substantially perpendicular to the conveying direction.

6. The sheet conveying device according to claim 1, wherein
in a conveying surface of the endless belt of the third conveyer, a length in a conveying width direction substantially perpendicular to the conveying direction is shorter than a length in the conveying direction.

7. The sheet conveying device according to claim 1, wherein
conveying surfaces of the first conveyer, the second conveyer, and the third conveyer are arranged on the substantially same plane.

8. The sheet conveying device according to claim 1, wherein
rigidity of the endless belt of the third conveyer is smaller than rigidity of the endless belts of the first conveyer and the second conveyer.

9. The sheet conveying device according to claim 1, wherein
the endless belts of the first conveyer and the second conveyer are formed of metal, and the endless belt of the third conveyer is formed of rubber.

10. The sheet conveying device according to claim 1, wherein
the third conveyer is a belt-attraction-type conveyer including a suction mechanism on a side of an inner periphery relative to the conveying surface of the endless belt.

11. The sheet conveying device according to claim 10, wherein
each of suction mechanisms of the first conveyer, the second conveyer, and the third conveyer includes a platen for supporting the endless belt from the side of the inner periphery,
the platens of the first conveyer and the second conveyer are formed of a porous material, and
the platen of the third conveyer has a configuration in which a plurality of through-holes is provided in a plate-like agent.

12. An image forming device comprising:
the sheet conveying device according to claim 1;
an image former that is arranged to face a conveying surface of the first conveyer; and
an image post-processor that is arranged to face a conveying surface of the second conveyer.

13. The sheet conveying device according to claim 2, wherein
the plurality of third conveyers is arranged between the first conveyer and the second conveyer and aligned along a conveying width direction substantially perpendicular to the conveying direction.

14. The sheet conveying device according to claim 2, wherein
in a conveying surface of the endless belt of the third conveyer, a length in a conveying width direction substantially perpendicular to the conveying direction is shorter than a length in the conveying direction.

15. The sheet conveying device according to claim 2, wherein
conveying surfaces of the first conveyer, the second conveyer, and the third conveyer are arranged on the substantially same plane.

16. The sheet conveying device according to claim 2, wherein
rigidity of the endless belt of the third conveyer is smaller than rigidity of the endless belts of the first conveyer and the second conveyer.

17. The sheet conveying device according to claim 2, wherein
the endless belts of the first conveyer and the second conveyer are formed of metal, and the endless belt of the third conveyer is formed of rubber.

18. The sheet conveying device according to claim 2, wherein
the third conveyer is a belt-attraction-type conveyer including a suction mechanism on a side of an inner periphery relative to the conveying surface of the endless belt.

19. An image forming device comprising:
the sheet conveying device according to claim 2;
an image former that is arranged to face a conveying surface of the first conveyer; and
an image post-processor that is arranged to face a conveying surface of the second conveyer.
